(19) United States
(12) Patent Application Publication
(10) Pub. No.: US 2011/0255016 A1
(43) Pub. Date: Oct. 20, 2011

(54) NOTEBOOK COMPUTER WITH PROJECTION FUNCTION

(75) Inventors: CHIA-SHIN CHOU, Tu-Cheng (TW); XIANG CAO, Shenzhen City (CN); ZHEN-XING YE, Shenzhen City (CN)

(73) Assignees: HON HAI PRECISION INDUSTRY CO., LTD., Tu-Cheng (TW); HON FU JIN PRECISION INDUSTRY (ShenZhen) CO., LTD., Shenzhen City (CN)

(21) Appl. No.: 12/784,721

(22) Filed: May 21, 2010

(30) Foreign Application Priority Data
Apr. 16, 2010 (CN) 201010148839.1

(51) Int. Cl. H04N 9/31

(52) U.S. Cl. 348/744; 348/E09.025

(57) ABSTRACT

A notebook computer includes a central processing unit, a video card, a display coupled to the video card, a projecting module, and a projector driving module. The video card is coupled to the central processing unit via a bridge and configured to receive graphical information from the central processing unit. The projecting module is coupled to the video card. The projector driving module is coupled to the projecting module and configured to activate the projecting module. The video card is capable of generating and outputting images to the display or the projecting module according to the graphical information as desired. The projecting module is capable of projecting the images after being activated by the projector driving module.

### TECHNICAL FIELD

The present disclosure relates to notebook computers, and more particularly relates to a notebook computer with a projection function.

### DESCRIPTION OF RELATED ART

Notebook computers, employing liquid crystal displays (LCD) are useful for travelling with considerable amounts of information that needs to be displayed in a distant office or boardroom. To display information stored in notebook computers, it must be printed or displayed on the notebooks LCD panel. During conferences, meetings and seminars, it is more convenient to project information onto screens. However, typical notebook computers do not have a projection function. Therefore, projectors have to be coupled to the notebook computers for projecting information onto screens. Some notebook computers do not have video connectors, and the projectors cannot be connected to these notebook computers.

### BRIEF DESCRIPTION OF THE DRAWINGS

FIG. 1 is a block diagram of a notebook computer according to an embodiment.

FIG. 2 depicts a detailed block diagram of a video card according to an embodiment.

FIG. 3 depicts a detailed block diagram of a projecting module according to an embodiment.

FIG. 4 is a view of a notebook computer with projection function according to an embodiment.

### DETAILED DESCRIPTION

The disclosure is illustrated by way of example and not by way of limitation. In the figures of the accompanying drawings in which like references indicate similar elements. It should be noted that references to “an” or “one” embodiment in this disclosure are not necessarily to the same embodiment, and such references mean at least one.

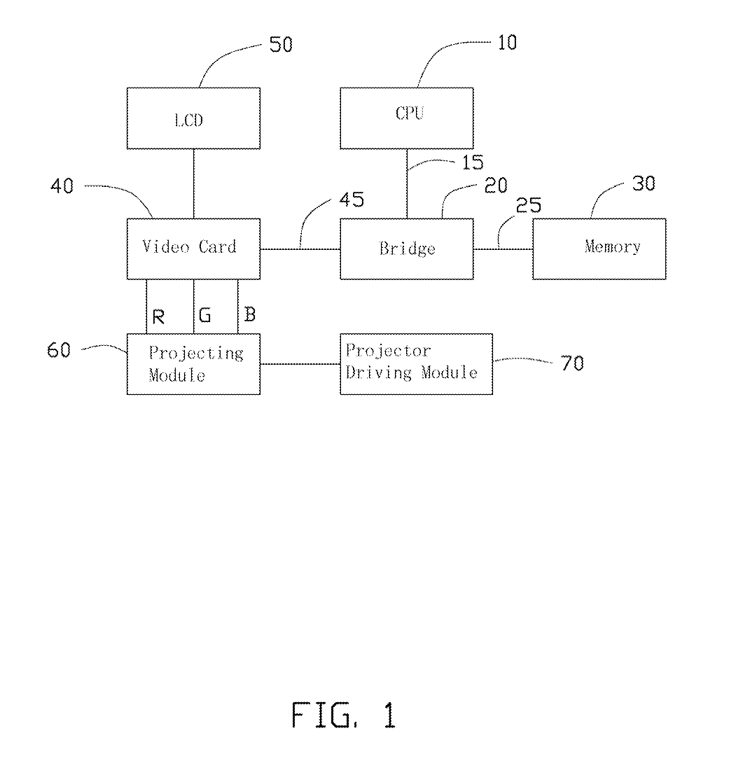

Referring to FIG. 1, an embodiment of a notebook computer includes a central processing unit (CPU) 10, a bridge 20 coupled to the CPU 10, a memory 30 coupled to the bridge 20, a video card 40 coupled to the bridge 20, a Liquid Crystal Display (LCD) 50 coupled to the video card 40, a projecting module 60 coupled to the video card 40, and a projector driving module 70 coupled to the projecting module 60. In one embodiment, the bridge 20 is coupled to the CPU 10 via a front side bus (FSB) 15; the memory 30 is coupled to the bridge 20 via a memory bus 25; and the video card 40 is coupled to the bridge 20 via an Accelerated Graphics Port (AGP) bus 45. After the notebook computer is powered on, the CPU 10 of the notebook computer outputs graphical information to the video card 40. The video card 40 generates and outputs images to the LCD 50 or the projecting module 60 according to the graphical information. If the projecting module 60 is not activated by the projector driving module 70, the LCD 50 displays the images. If the driving module 70 activates the projecting module 60, the projecting module 60 projects the images.

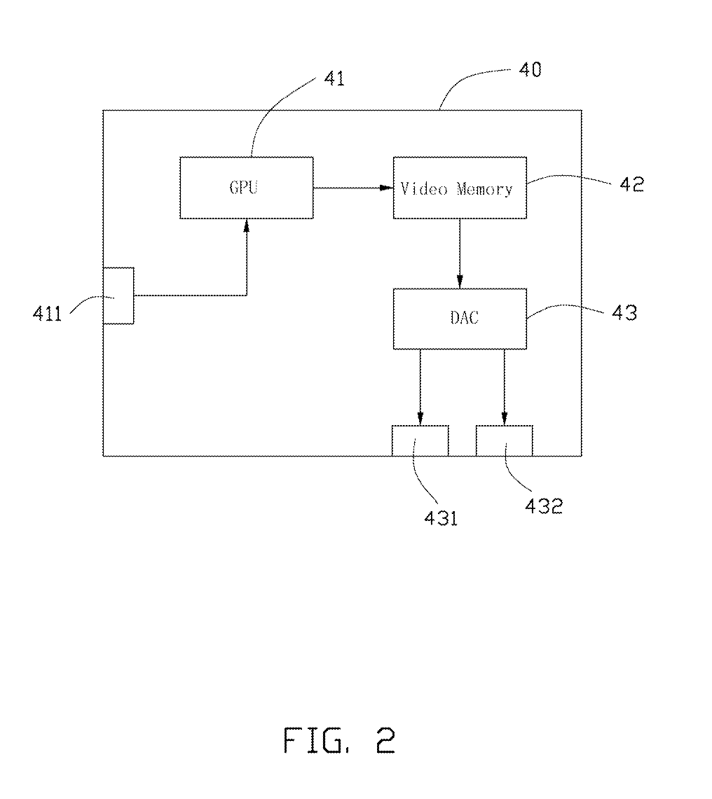

Referring to FIG. 2, the video card 40 includes a graphics processing unit (GPU) 41, a video memory 42 coupled to the GPU 41, and a digital-to-analog convertor (DAC) 43 coupled to the video memory 42. The video card 40 has a first interface 411, a second interface 431, and a third interface 432. The first interface 411 is coupled to the bridge 20 for receiving the graphical information from the CPU 10. The GPU 41 is configured to process the graphical information and output digital video signals to the video memory 42. The video memory 42 is configured to temporarily store the digital video signals output from the GPU 41. The DAC 43 is configured to convert the digital video signals to analog video signals which form the images. The second interface 431 is configured to send the images to the LCD 50. The third interface 432 is configured to send the images to the projecting module 60. The images include red, green, blue (RGB) signals, which can be sent to the projecting module 60 via the third interface 432.

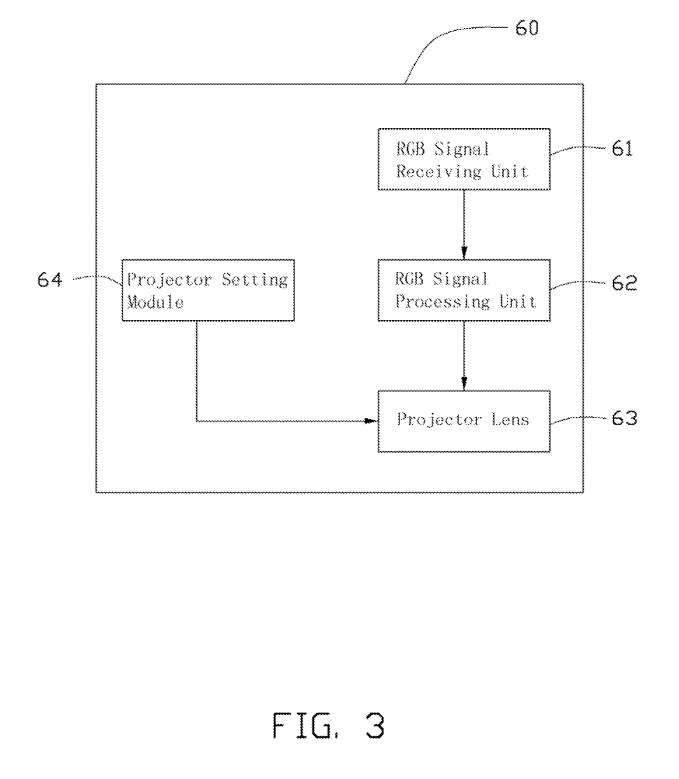

Referring to FIG. 3, the projecting module 60 includes a RGB signal receiving unit 61, a RGB signal processing unit 62 coupled to the RGB signal receiving unit 61, a projector lens 63 is coupled to the RGB signal processing unit 62, and a projector setting module 64 is connected the projector lens 63. The RGB signal receiving unit 61 is configured to receive the RGB signals from the third interface 432 of the video card 40. The RGB signal processing unit 62 is configured to process the RGB signals and convert the RGB signals to projectable light signals. The projector lens 63 can project the projectable light signals to the screen. The projector setting module 64 is coupled to the projector lens 63 for setting a zoom ratio and a focus of the projector lens 63.

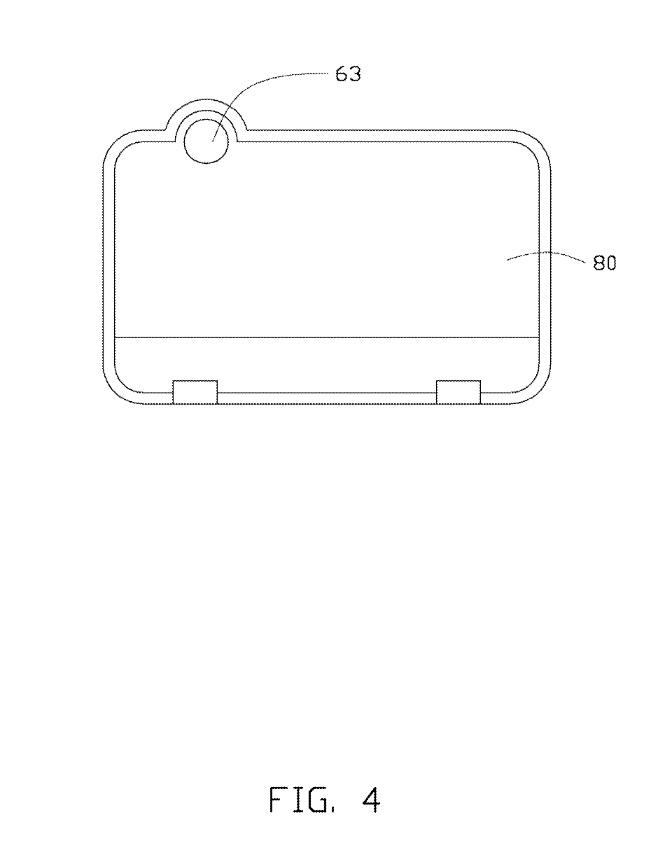

Referring to FIG. 4, in one embodiment, the projector lens 63 is mounted on a housing 80 of the notebook computer. After the notebook computer is powered on, the projector driving module 70 can be utilized to enable the projecting module 60. Then the projecting module 60 receives RGB signals from the video card 40 and converts the RGB signals to projectable light signals. The projector lens 63 projects the projector light signals to a screen. The notebook computer facilitates users to project information onto the screen without using additional projectors.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present invention will readily appear to those skilled in the art. Therefore, the present disclosure is not limited to the specific details and illustrative examples shown and described.

What is claimed is:

1. A notebook computer comprising:
a central processing unit;
a video card, coupled to the central processing unit via a bridge, configured to receive graphical information from the central processing unit;
a display coupled to the video card;
a projecting module coupled to the video card; and
a projector driving module, coupled to the projecting module, configured to activate the projecting module;
wherein the video card is capable of generating and outputting images to the display and the projecting module, and the projecting module is capable of projecting the images onto a screen after being activated by the projector driving module.

2. The notebook computer of claim 1, wherein the video card comprises a first interface coupled to the central processing unit via the bridge and a graphics processing unit coupled to the first interface; and the first interface is configured to receive the graphical information from the central processing unit, the graphics processing unit is configured to process the graphical information and generates digital video signals.

3. The notebook computer of claim 2, wherein the video card further comprises a video memory configured to temporarily store the digital video signals outputted from the graphics processing unit.

4. The notebook computer of claim 3, wherein the video card further comprises a digital-to-analog convertor coupled to the video memory, and the digital-to-analog convertor is capable of converting the digital video signals to analog video signals that form the images.

5. The notebook computer of claim 4, wherein the video card further comprises a second interface and a third interface that are both coupled to the digital-to-analog convertor, the second interface is configured to output the images to the display, and the third interface is configured to send the images to the projecting module.

6. The notebook computer of claim 5, wherein the images comprises red, green, blue (RGB) signals, and the third interface of the video card is capable of outputting the RGB signals to the projecting module.

7. The notebook computer of claim 6, wherein the projecting module includes a RGB signal receiving unit that is configured to receive the RGB signals from the video card.

8. The notebook computer of claim 7, wherein the projecting module further comprises a RGB signal processing unit that is coupled to the RGB signal receiving unit, and the RGB signal processing unit is capable of processing the RGB signals and generating projectable light signals.

9. The notebook computer of claim 8, wherein the projecting module further comprises a projector lens that is configured to receive the projectable light signals and project the projectable light signals to the screen.

10. The notebook computer of claim 9, wherein the projecting module further comprises a projector setting module coupled to the projector lens, and the projector setting module is capable of setting a zoom ratio and a focus of the projector lens.

11. A notebook computer comprising:
a central processing unit;
a display;
a projecting module;
a video card that allows the central processing unit to send graphical information to the display and/or the projecting module;
wherein the video card has a first interface configured to receive the graphical information, a second interface configured to send the graphical information to the display, and a third interface configured to send the graphical information to the projecting module.

12. The notebook computer of claim 11, wherein the video card comprises a graphics processing unit coupled to the first interface, and the graphics processing unit is configured to process the graphical information and generate digital video signals.

13. The notebook computer of claim 12, wherein the video card further comprises a digital-to-analog convertor coupled to the graphics processing unit, and the digital-to-analog convertor is capable of converting the digital video signals to analog video signals and sending the analog video signals to the second interface and the third interface.

14. The notebook computer of claim 13, wherein the analog video signals comprises red, green, blue (RGB) signal, and the third interface of the video card is capable of sending the RGB signals to the projecting module.

15. The notebook computer of claim 14, wherein the projecting module comprises a RGB signal receiving unit, a RGB signal processing unit coupled to the RGB signal receiving unit, and a projector lens coupled to the RGB signal processing unit.

16. The notebook computer of claim 15, wherein the projecting module further comprises a setting module coupled to the projector lens, and the setting module is configured to set a zoom ratio and a focus of the projector lens.

17. The notebook computer of claim 11, further comprising a projector driving module coupled to the projecting module, and the projector driving module is capable of activating the projecting module.
